(19) United States
(12) Patent Application Publication
(10) Pub. No.: US 2026/0241611 A1
(43) Pub. Date: Aug. 20, 2026

(54) METHOD FOR RECYCLING PAINTED PLASTICS

(71) Applicant: Recosal GmbH, St. Ingbert (DE)

(72) Inventor: Christoph GROSS, Neunkirchen (DE)

(73) Assignee: Recosal GmbH, St. Ingbert (DE)

(21) Appl. No.: 19/156,532

(22) PCT Filed: Feb. 23, 2024
(86) PCT No.: PCT/DE2024/100150

§ 371 Date: Aug. 14, 2025

(30) Foreign Application Priority Data
Feb. 24, 2023 (DE) 10 2023 104 535.0

(51) Int. Cl. B29B 9/06; B29B 17/02

(52) U.S. Cl. CPC B29B 9/06; B29B 17/02; B29B 2017/0265

(57) ABSTRACT

A method for recycling painted plastic parts, without the addition of chemicals, makes it possible to obtain granulate whose physical properties are almost identical to those of new material. In the method, the plastic parts are comminuted in one or more steps to a particle size in the range of approx. 50 to 500 μm, the plastic particles are then fed to an extruder, which, after a melting and kneading phase and filtration, extrudes a plastic strand, and the plastic strand is then granulated. This method produces-preferably without the addition of chemicals-a plastic granulate that can also be used to manufacture painted plastic parts with physical properties that are almost identical to those of new material.

The invention relates to a method for recycling painted plastic parts.

Plastic products are frequently used for motor vehicle parts. When, for example, plastic bumpers with unpainted surfaces are recycled, incorrectly moulded bumpers and bumpers removed from scrap vehicles are roughly crushed into cubes measuring approximately 3 mm and then mixed with pure or new material and reused for moulding bumpers. This is possible because the physical properties of recycled plastic material are not significantly worse than those of new material.

However, in the case of plastic parts with painted surfaces, plastic materials recovered in this way cannot be reused for identical new parts. This is because when painted plastic parts are crushed, the paint deteriorates the physical properties of the plastic material, such as impact resistance, elongation and surface quality, to such an extent that a satisfactory quality can no longer be achieved for a new part.

For this reason, painted plastic parts that have been moulded incorrectly or removed from scrap vehicles are deposited in landfills or incinerated, which is harmful to the environment.

The state of the art includes methods for removing paint by sandblasting. Sandblasting materials are blown onto the paint on the painted plastic parts using compressed air to mechanically remove the paint.

Methods for melting the resin and separating the paint using a screening device are also known. A painted plastic part is coarsely crushed and fed into an extruder, where the plastic part is melted. Since the paint does not melt in the extruder due to its heat curing, it can be separated by means of a sieve device attached to the outlet of the extruder.

Methods are also known for removing paint from plastic using chemicals.

EP 1 205 513 A2 describes a method for removing paint from plastic bodies coated with layers of paint, in which these are first crushed to a pourable particle size. These plastic parts are then mixed with a paint stripper that reduces the adhesion of the paint layers on them and circulated by means of a screw conveyor. The paint stripper is formed from an emulsion of at least one benzyl-substituted alkanol, an alkyl glycol acetate or N-alkylpyrrolidone with an aqueous lye, which cannot be completely mixed. The mixing ratio of the individual components of the paint stripper is selected so that it lies within the range of a mixing gap. After the paint stripper has acted on the painted plastic parts, a liquid-absorbing solid is added to it so that the rest of the process can be carried out dry. The plastic parts are then fed into a hammer mill, where the paint layers swollen by the paint stripper are knocked off the plastic parts. Due to the chemicals used, this process is complex, costly and also harmful to the environment.

There are also processes in which the plastic parts are crushed and mixed with new plastic.

According to DE 197 15 945A1, shredded plastic parts are placed in a hammer mill and set in motion with PA 66 GF 30 plastic granulate. The heat and impact loosen the paint particles, leaving the plastic particles largely free of paint.

Finally, there are purely mechanical processes for recycling painted plastic parts.

EP 0 575 751 A1 and DE 42 17 005 A1 describe a process in which painted plastic parts are finely crushed into chips in several stages but are not pulverised. Due to differences in density, the chips are separated into a sink fraction and a float fraction in a float-sink plant. The floating fraction, which consists mainly of plastics, is then ground, with the good fraction having an average fibre length of 1 to 3 mm. The good fraction is subjected to shearing, which removes the adhering paint particles. The detached paint is screened out and removed in a vibrating screen. The paint-free good fraction is transferred to a vacuum granulating extruder for further processing, resulting in recycled plastic in the form of granulate. Due to the significantly higher proportion of fillers and the better adhesion of the paint in the paint systems developed in the 1990s, as well as the higher filler content of the plastics, this method is no longer possible for newer painted plastic products.

The invention therefore aims to provide a method for recycling painted plastic materials which, preferably without the addition of chemicals, makes it possible to obtain a granulate whose physical properties are almost identical to those of new material.

This objective is solved by the invention by means of a process in which
the plastic parts are comminuted in one or several steps to a particle size in the range of approx. 50 to 500 μm,
wherein the plastic particles are then fed to an extruder, which, after a melting and kneading phase and filtration, extrudes a plastic strand, and
the plastic strand is then granulated.

The particle size refers to the average particle size in each case.

It was surprisingly discovered in the course of the invention that this method produces plastic granulate from single-type plastic parts that can also be used to produce painted plastic parts with physical properties that are almost identical to those of new material. The method according to the invention can be carried out without the addition of chemicals. Contrary to the procedure described in EP 0 575 751 A1 and DE 42 17 005A1 , the plastic is not stripped of paint prior to extrusion (which would no longer be possible with today's painted plastics using the method described there) but is extruded with the paint still adhering to it.

In a preferred embodiment of the invention, the plastic parts are comminuted in one or more steps to a particle size of approx. 100 to 400 μm and, particularly preferably, approx. 200 to 300 μm.

It is possible to reuse only the recycled plastic granulate as raw material for the production of new plastic parts for the original or a new application.

However, it is preferred that the recycled plastic granulate obtained and/or recycled plastic granulate from unpainted pre-material be mixed with new plastic to produce new plastic parts for the original or a new application.

Pure plastic granulate recycled in accordance with the present invention from painted pre-material can be mixed with new plastic, and plastic granulate recycled in accordance with the present invention from painted pre-material can be mixed with recycled plastic granulate from unpainted pre-material, and this mixture can in turn be mixed with new plastic. The respective type and composition of the mixture depends on the respective product requirements.

In this case, the mixture contains, for example, between 10 and 90% by weight of recycled plastic granulate and/or recycled plastic granulate from unpainted plastic parts, preferably between 20 and 80% by weight and particularly preferably between 30 and 50% by weight.

An advantageous feature of the invention is that the plastic parts are comminuted in several steps, whereby pre-comminution is first carried out, for example by means of a shredder, then optionally intermediate comminution, for example in a cutting mill, and finally grinding of the plastic parts, for example in a disc mill or a vibrating mill.

Within the scope of the invention, it is preferred that, after the plastic parts have been comminuted, electrostatic separation takes place, during which paint particles that have detached from the plastic during separation are removed.

This electrostatic separation preferably takes place after the plastics have been crushed and before grinding.

After pre-shredding, the plastic parts preferably have a size of approx. 20 to 80 mm, and after intermediate shredding, they have a size of approx. 4 to 20 mm. Depending on the starting product and the selected shredding process, the plastic parts may also have other dimensions after the individual process steps, and it is also possible to omit the intermediate reduction step and proceed directly from pre-shredding to grinding.

It is also preferred that the ground material is cooled during the grinding of the plastic parts. Cooling the ground material achieves a better grinding result. Plastic particles with a particle size of approx. 50 to 500 μm (hereinafter referred to as ‘ground material’) are now present, which are then subjected to extrusion.

According to the invention, the extruder is a single-screw extruder or a twin-screw extruder, the latter being preferred. In twin-screw extruders, the plastic is exposed to higher shear forces, which is advantageous for the present application. Filtration is preferably carried out by means of a melt filter.

Preferably, an additive containing a stabiliser and an impact modifier is added to the regrind before or during extrusion. Between 0.5 and 3% by weight of additive is added, based on the amount of regrind. This further improves the quality of the end product.

If necessary, the additive may also contain odour absorbers. This is particularly useful if the end product is to be used indoors.

Preferred embodiments of the invention consist in granulating the plastic strand by means of strand granulation or underwater granulation, the former being preferred.

However, other granulation methods can also be used.

It is within the scope of the invention that the plastic parts are painted plastic parts from motor vehicles.

These can be painted bumpers, for example. Of course, other painted plastic parts from motor vehicles or other areas can also be recycled using the method according to the invention.

The method according to the invention is generally suitable for all painted plastics, in particular PA, PE, PP, PC, PET, whereby non-fibre-reinforced plastics are preferred. An embodiment of the invention is explained in more detail below with reference to a drawing.

It is shown in

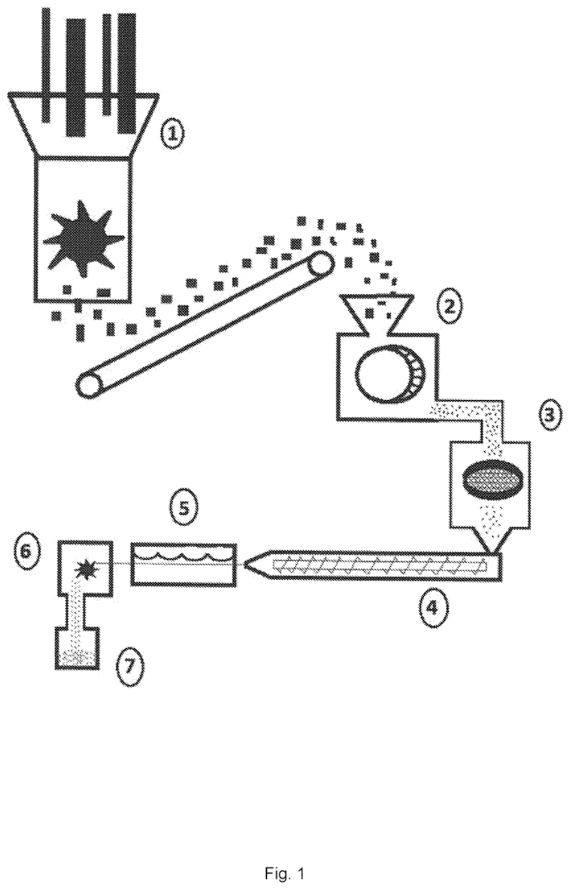

FIG. 1 the schematic sequence of a process according to the invention for recycling painted plastic parts.

First, the plastic parts are pretreated manually or mechanically, if necessary, so that the plastic parts are sorted by type.

In a first step, the plastic parts are pre-shredded in a shredder to a size of approx. 20 to 80 mm. Before or after this step, metal parts are sorted and/or removed.

The pre-shredded plastic parts are fed by a conveyor belt to a cutting mill (1), where they are shredded to a size of approx. 4 to 20 mm.

Any paint parts that have come loose during this process are then removed by means of an electrostatic separation system (not shown).

The plastic parts are then transported to a disc mill (2) via a conveyor belt or a screw conveyor system. In the disc mill (2), the plastic parts are then crushed to a particle size of approx. 300 μm and then fed into a screening plant (3), which ensures the desired particle size.

The result is plastic particles with a particle size of approx. 50 to 500 μm (hereinafter referred to as ‘ground material’), which are then subjected to extrusion.

Before or during extrusion, 1% by weight of the plastic particles is added to an additive containing a stabiliser and an impact modifier and, if necessary, an odour absorber.

The sieved plastic particles are fed via a dosing unit to an extruder (4), which is either a single-screw extruder or a twin-screw extruder, depending on the material, the latter being preferred. The extrusion includes a melting and kneading phase.

Following extrusion, the plastic is granulated, preferably by means of strand granulation (6) in a water bath (5), although alternative granulation methods may also be used.

The granulate, which has a size of approximately 3 to 8 mm, for example, is screened using a glass sieve and fed to a packaging unit (7).

If necessary, homogenisation of both the intermediate products of the process and the granulate can also be carried out.

1. A process for recycling painted plastic parts, comprising the following process steps:
comminution of the plastic parts in several steps into plastic particles with a particle size in the range of 50 to 500 μm, wherein the comminution of the plastic parts takes place in several steps, initially by pre-comminution, then optionally by intermediate comminution, and finally by grinding of the plastic parts,
wherein, prior to grinding, electrostatic separation is carried out, in which the paint particles that have detached from the plastic particles are removed,
feeding the plastic particles into an extruder, with which, after a melting and kneading phase and filtration, a plastic strand is extruded, and
the plastic strand is then granulated.

2. A method according to claim 1, wherein the plastic parts are reduced to an average particle size of approx. 100 to 400 μm and particularly preferably approx. 200 to 300 μm.

3. The method according to claim 1, wherein only the recycled plastic granulate is reused as raw material for the production of new plastic parts for the original or a new application.

4. The method according to claim 1, wherein the recycled plastic granulate obtained from painted pre-material is mixed with new plastic to produce new plastic parts for the original or a new use, the mixture containing between 10 and 90% by weight, preferably between 20 and 80% by weight and particularly preferably between 30 and 50% by weight of recycled plastic granulate.

5. The method according to claim 1, wherein the plastic parts are ground in a disc mill (2) or a vibrating mill.

6. The method according to claim 5, wherein after pre-crushing, plastic parts with a size of approx. 20 to 80 mm are present and after intermediate crushing, plastic parts with a size of approx. 4 to 20 mm are present.

7. (canceled)

8. The method according to claim 1, wherein the ground material is cooled during the grinding of the plastic parts.

9. The method according to claim 1, wherein a single-screw extruder or a twin-screw extruder is used as the extruder, with a twin-screw extruder being preferred.

10. The method according to claim 1, wherein, prior to extrusion, an additive containing a stabilizer and an impact modifier is added to the plastic particles in an amount of between 0.5 and 3% by weight, based on the amount of plastic particles.

11. The method according to claim 9, wherein the additive contains odor absorbers.

12. The method according to claim 1, wherein the plastic strand is granulated by means of strand granulation (6) or underwater granulation.

13. The method according to claim 1, wherein the plastic parts are painted parts of motor vehicles.
